(19) United States
(12) Patent Application Publication
(10) Pub. No.: US 2017/0178486 A1
(43) Pub. Date: Jun. 22, 2017

(54) Method by controlling and transmitting alarm signals from a number of alarms to an earplug

(71) Applicant: Henrik HAUGE, Hammel (DK)

(72) Inventor: Henrik HAUGE, Hammel (DK)

(21) Appl. No.: 15/116,324

(22) PCT Filed: Feb. 4, 2015
(86) PCT No.: PCT/DK2015/000005

§ 371 Date: Aug. 3, 2016

(30) Foreign Application Priority Data
Feb. 4, 2015 (DK) PA 2014 00062

(51) Int. Cl. G08B 21/18; H04W 4/00

(52) U.S. Cl. CPC G08B 21/18; H04W 4/008; H04R 1/1016

(57) ABSTRACT

By a method in controlling and transmitting alarm signals from a number of alarms to a user's earplug, said earplug having a receiver, each alarm has a sensor, such as a microphone, that is adapted to transfer by the user selected alarm signals to a communication unit, being a smartphone (Iphone) a smart watch (Iwatch) or the like. From the communication unit the user can chose what alarms, at a given time slot, should be transferred to the user's ear. In order to further do it possible to transfer alarms remote from the user, such alarms are transferred to the user from the communication unit, via a router.

The invention relates to a method by controlling and transmitting alarm signals from a number of alarms to an earplug.

Moreover, the invention relates to a use of the method.

In case that a user want to exclude sounds and noises from the environment, or if a user stay in noisy environments, it is a problem that sound given alarm signals are also prevented in case it is important that the alarm is registered by the user, even that the user carries an earplug.

Some users, using earplugs, have also the problem getting back to sleep if they are waked inappropriate.

It is on this basis an object with the invention to provide a method, where all important alarms become transferred to a user, even that the user uses an earplug to exclude sounds form the surroundings.

The object is fulfilled with a method, as defined in the introductory part of claim 1 that comprises the following steps:
a) The alarms are connected to a wireless communication unit
b) When an alarm is initiated the alarm submit an alarm activating signal
c) The alarm activation signal is transferred to the communication unit
d) The communication unit submit control commands to a receiver in in the earplug, some of which, of the user-selected alarms, via the communication unit, activates the alarms and transfer these to the user's ear via the receiver in the earplug.

In this way, it is possible to choose exactly those alarms that is wanted to be transferred to a user's earplug in a given situation.

By use of the principles in connection with existing alarms, it is advantageous, if, as stated in claim 2, that each alarm-activating signal is provided by, to the alarms, connected sensors.

To secure that the user not intentionally disrupts an alarm, f. inst. a smoke alarm, to a user's earplug, it is advantageous, if, as stared in claim 3, that some of the alarm signals will always be transferred to the earplug.

In order to secure a stable connection by transferring alarm signals where various standards for transferring the signals are used, it is an advantage, if, as defined in claim 4, a transceiver, is connected between the sensors and the communication unit, and as stated in claim 5, that a router is coupled between the communication unit and the transceiver.

A simple way to provide connections from alarms emitting sound signals are, as stated in claim 6, that in the sensors a microphone is built in said microphone is adapted to transfer sound alarm signals to the transceiver or the communication unit.

Another well recognised solution by transferring signals between the communication unit and the transceiver are, as stated in claim 7, that the alarm signals are transferred to the communication unit via a Bluetooth connection to the earplug, or, as stated in clam 8, that the alarm activating signals are transferred from the communication unit via a wire loop.

A useful communication unit is, as stated in claim 9, that the communication unit is a Smartphone, a tablet, a Smartwatch or the like.

Further expedient embodiments of the invention are defined in claims 10 and 11.

As mentioned, the invention also relates to a use.

This use is defined in claim 12.

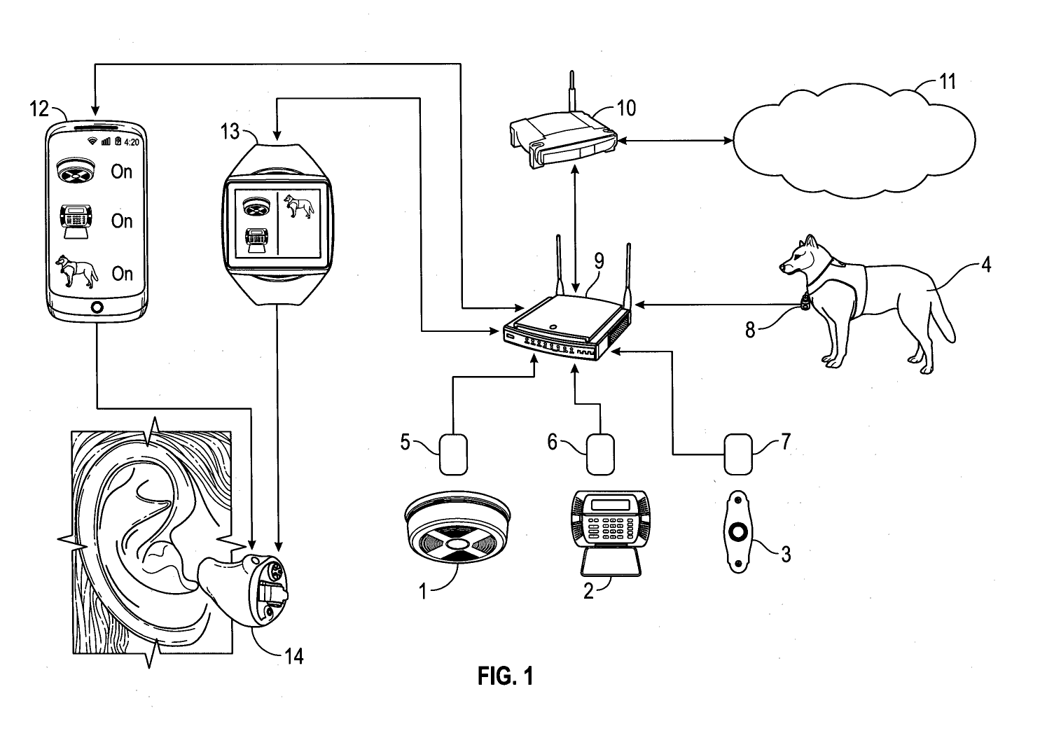

The invention will now be explained in connection with the drawings sole FIG. 1.

On FIG. 1, 1 denotes a smoke alarm, 2 denotes a burglar alarm, 3 denotes a door bell, and 4 a dog having an alarm 8, all items being able to emit an alarm, f. inst a sound alarm.

It is also possible to connect other types of alarms including light signals.

To each of the alarms is, but not necessarily, connected sensors, being denoted 5, 6, 7, whereas the alarm 8 has an in-built sensor.

These sensors can accommodate a microphone for registering sound signals from the alarms.

If an alarm submits light signals, then the sensors can accommodate light sensitive diode receivers, in the same way, as it is known from a remote control to a TV set.

As it can be seen on the figure, the sensors are coupled wireless to a transceiver 9.

This transceiver 9 operates as a collection unit for signals coming from the sensors, and is intended to transfer alarm signals to a communication unit, that is, as here shown, a Smartphone 12 or a Smartwatch 13. Other types of communication units can of course be used as well.

The communication unit has a wireless connection to a user's earplug 14. Other available wireless connections can also be used, such as a wireless loop, where a magnetic field transfer sound to an earplug or the wireless connection can be a Bluetooth.

It is possible for a user to set what signals the user want to transmit to his to earplug. The type of signals can be sound a signal, vibration signal or music. During sleep, it is possible, via the communication unit, to disrupt a phone call, if that is desired. It is also possible to allow selected persons, in certain time slots, to activate an alarm.

To the contrary, it will not be advantageous to disrupt a fire alarm.

As it further can be seen on the figure, a router 10 can be coupled to the transceiver 9, through said router 10 remote alarms via the Internet 11 can communicate alarms through the router 10 and the transceiver 9 to the communication unit.

A remote alarm could f. inst. be a fire alarm, a burglar alarm in a shop, being distant displaced from a user's residence.

Moreover, it is noted that it is possible within the scope of claims, to form the sensors in such a way that they have direct connection to the communication unit without use of a transceiver and the Internet.

An example could be a need for controlling alarm from a doorbell and a fire alarm, but such that the fire alarm, as mentioned, must not be disabled.

It is noted that the communication unit itself can be provided as a so-called App, being intended for controlling alarm signals from sensors, said sensors could be implemented as part of the alarm itself.

Even that the invention is explained in connection with a specific embodiment, nothing is prevented within the scope of the claims to implement the invention in the following communication configurations in which RF is used.
1. From sensor, to transceiver.
2. From sensors with built in alarms to transceiver.
3. From alarm with built in sensor to communication unit.
4. From sensor, direct to the communication unit.

Finally, it is noted, that as the communication unit can be a Smartphone, it is possible, via to the Smartphone coupled so called surveillance App. to measure body temperature, pulse rate, heart rhythm and the like. In case that the measured values becomes critical, then a warning signal can be transmitted to a person's earplug during his sleep. If the value deviates from critical values, then the user can use the signals to control the quality and pattern of his or hers sleep, f. inst. by being waked when the person sleeps lightly or at a time set by the user.

It is also possible to use an accelerometer in order to detect the user's movements during his or her sleep. The above mentioned measurements can be provided with sensors that are accommodated in the earplug.

1. Method by controlling and transmitting alarm signals from a number of alarms to an earplug, said earplug is mounted in a user's ear, said earplug it adapted to exclude sounds to the users ear and where the method comprises the following steps:
a) The alarms are connected to a wireless communication unit
b) When an alarm is initiated the alarm submit an alarm activating signal
c) The alarm activation signal is transferred to the communication unit
d) The communication unit submit control commands to a receiver in in the earplug, some of which, of the user-selected alarms, via the communication unit, activates the alarms and transfer these to the user's ear via the receiver in the earplug.

2. Method according to claim 1, characterized in that each alarm-activating signal is provided by, to the alarms, connected sensors.

3. Method according to claims 1-2, characterized in that some of the alarm signals will always be transferred to the earplug.

4. Method according to claims 2-3, characterized in that a transceiver, is connected between the sensors and the communication unit.

5. Method according to claims 1-4, characterized in that a router is coupled between the communication unit and the transceiver.

6. Method according to claims 1-5, characterized in that in the sensors a microphone is built in, said microphone is adapted to transfer sound alarm signals to the transceiver or the communication unit.

7. Method according to claims 1-6, characterized in that the alarm signals are transferred to the communication unit via a Bluetooth connection to the earplug.

8. Method according to claims 1-7, characterized in that the alarm activating signals are transferred from the communication unit via a wire loop.

9. Method according to claims 1-8, characterized in that the communication unit is a Smartphone, a tablet, a Smartwatch or the like.

10. Method according to claims 1-9, characterized in that the earplug comprises detectors being adapted to measure heart pulse, temperatures, movements or the like.

11. Method according to claims 1-10, characterized in that the earplug comprises a rechargeable battery being recharged by induction coils.

12. Use of the method according to claims 1-11 in implementing the method as an App for the communication unit.
